(19) United States
(12) Patent Application Publication
(10) Pub. No.: US 2021/0395921 A1
(43) Pub. Date: Dec. 23, 2021

(54) SPANDEX FIBER WITH REDUCED VISIBILITY

(71) Applicant: The LYCRA Company LLC, Wilmington, DE (US)

(72) Inventors: Robert DEWHURST, Gloucester (GB); Geoffrey D. HIETPAS, Newark, DE (US); Giovanni PARINI, Marcallo Con Casone (IT); Ambata M. POE, Wilmington, DE (US); Steven W. SMITH, Waynesboro, VA (US); Mary WAHLSTROM, Waynesboro, VA (US)

(73) Assignee: The LYCRA Company LLC, Wilmington, DE (US)

(21) Appl. No.: 17/292,777

(22) PCT Filed: Nov. 9, 2019
(86) PCT No.: PCT/US2019/060656

§ 371 Date: May 11, 2021

Related U.S. Application Data
(60) Provisional application No. 62/758,844, filed on Nov. 12, 2018.

(51) Int. Cl. D01F 1/10; C08K 13/02; D01F 1/04; D01F 6/70

(52) U.S. Cl. CPC D01F 1/10; C08K 13/02; C08K 3/04; D01F 6/70; D01F 1/04

(57) ABSTRACT

Spandex fiber compositions with reduced grin-through effect are provided. Also provided are methods for production and use of these compositions.

### FIELD OF THE INVENTION

This disclosure relates to spandex fiber compositions and methods for their production and use which contain carbon black pigment, a white opacity enhancer and an inorganic pigment or acid dye receptor and which exhibit reduced grin-through effect in stretch fabrics.

### BACKGROUND OF THE INVENTION

Fabrics containing spandex are oftentimes combined with another companion yarn such as, but not limited to, cotton, nylon, polyester, wool or acrylic. These fabrics are usually dyed in colors with dyes having chemical structures specifically designed to be compatible for the specific companion yarn.

In some cases, the spandex fiber is knit, plated, or woven into the fabric with the companion yarn prior to dyeing and therefore is also exposed to this dye process. However, as the dye chemistry is not intentionally formulated for the spandex fiber, which varies in chemistry and linear density or decitex from the companion yarn, the resulting shade on the spandex fiber can differ from that of the companion yarn.

In other cases, the companion yarn is dyed before making the fabric and the spandex fiber does not participate in a dye process at all. In these cases, the spandex will also have a different shade to the companion yarn in the fabric.

When knitted fabrics containing spandex are stretched, it opens the structure and enables the spandex to be more visible to the observer. When this occurs, and when the spandex has a different shade or a different luster, then the fabric has a very different, and often undesirable, appearance as compared to the fabric in its relaxed state. This effect is known in the art by the term ‘grin-through’.

Spandex fiber manufacturers have made various attempts to reduce the grin-through effect.

For example, attempts have been made to make the spandex more compatible with the dyes used on the companion yarn. These ‘dyeable’ spandex fibers are disclosed, for example, in published U.S. Application No. US2005/0165200, WO 2009/084815 and EP 2157215A1. However, they are limited to improving dyability with nylon acid dyes and shade matching a dyed spandex with a dyed nylon can be challenging due to the different decitex of each fiber and the different degrees of luster that they may each have.

A second method used commercially is to add a black pigment to the spandex fiber to make it less visible in fabrics, see for example, US 2006/0210794. This method is limited to fabrics that are intended to have dark shades, and it may still possess an undesirable grin-through or shine effect when stretched.

Fiber manufacturers have also attempted to minimize the glitter or shine aspects of grin-through using opacity enhancers in the fiber such as titanium dioxide. This is effective in increasing the opacity of the spandex fiber as well as increasing the degree of white appearance of the fiber, but samples in fabric still exhibit the undesirable grin-through effect in practical applications.

There exists a need for a spandex fiber that significantly reduces or eliminates the grin-through effect in stretch fabrics.

### SUMMARY OF THE INVENTION

The present disclosure relates a spandex fiber that exhibits significantly reduced grin-through effect in stretch fabrics as well as methods for its production and use.

Accordingly, as aspect of the present invention relates to a spandex fiber composition comprising spandex, carbon black pigment, a white opacity enhancer and an inorganic pigment and/or acid dye receptor.

Another aspect of the present invention relates to filaments and fiber for producing stretch fabrics with reduced grin. The fiber is produced from a spandex fiber composition comprising spandex, carbon black pigment, a white opacity enhancer and an inorganic pigment and/or acid dye receptor.

Another aspect of the present invention relates to a method for reducing grin-through effect of spandex in stretch fabrics. In this method, carbon black pigment, a white opacity enhancer and an inorganic pigment and/or acid dye receptor are added to a spandex fiber composition.

Yet another aspect of the present invention relates to an article of manufacture, at least a portion of which comprises a composition or fiber comprising spandex and carbon black pigment, a white opacity enhancer and an inorganic pigment and/or acid dye receptor.

### DETAILED DESCRIPTION OF THE INVENTION

This invention relates to spandex fiber compositions with reduced grin-through in stretch fabrics and methods for producing these compositions and using these compositions in fiber and filament production and in articles of manufacture.

Spandex fibers compositions of the present invention comprise spandex, carbon black pigment, a white opacity enhancer and an inorganic pigment or acid dye receptor.

The term “spandex” is used herein in its generic sense to mean a manufactured fiber in which the fiber-forming substance is a long chain synthetic polymer comprised of segmented polyurethane and/or polyurethane urea. Spandex compositions are well-known in the art and may include many variations such as those disclosed in Monroe Couper, Handbook of Fiber Science and Technology: Volume III, High Technology Fibers Part A. Marcel Dekker, INC: 1985, pages 51-85.

Carbon black pigment is added to the spandex. In one nonlimiting embodiment, a low level of carbon black pigment is added. By “low level” as used herein, it is meant about 25 ppm to about 200 ppm of carbon black pigment.

A white opacity enhancer is also added to the spandex. In one nonlimiting embodiment, the white opacity enhancer is titanium dioxide. In one nonlimiting embodiment, about 0.01 to about 1% by weight of white opacity enhancer is added. An opacity enhancer is titanium dioxide or any other material with a refractive index above 1.8 at 632.8 nanometers. In one nonlimiting embodiment, about 0.01 to about 1% of titanium dioxide is added.

In one nonlimiting embodiment, the spandex fiber composition further comprises an inorganic pigment. Nonlimiting examples of inorganic pigments which can be used include hydrotalcite, huntite, hydromagnesite, magnesium carbonate, calcium carbonate, magnesium oxide, magnesium hydroxide, and combinations thereof. In one nonlimiting embodiment, about 1% to about 10% by weight of inorganic pigment is added.

In an alternative nonlimiting embodiment, the spandex fiber composition further comprises acid dye receptor. In one nonlimiting embodiment, the acid dye receptor is from a tertiary and quaternary ammonium salt family or a combination thereof. In one nonlimiting about 10 to about 50 meq active N/kg fiber of acid dye receptor is included.

Also provided by the present invention are filaments and fiber having reduced grin-through effect produced from these spandex fiber compositions. Methods for production of such filaments and fibers are well known in the art and need not be described in detail herein.

In addition, the present invention provides articles of manufacture, at least a portion of which comprises a composition, filament or fiber of the present invention.

In one nonlimiting embodiment, the article of manufacture is fabric. In one nonlimiting embodiment, the fabric is stretch fabric.

Fabrics comprising spandex of the present invention may have a spandex content of about 0.5 weight percent (wt. %) to about 40 wt. %, based on weight of the fabric. For example, circular knits comprising spandex may contain from about 2 wt. % to about 25 wt. % spandex, leg wear comprising spandex may contain from about 1 wt. % to about 40 wt. % spandex, raschel fabric comprising spandex may contain from about 10 wt. % to about 40 wt. % spandex, and warp knit tricots comprising spandex may contain from about 14 wt. % to about 22 wt. % spandex.

Fabrics of the present invention may further comprise a companion fabric. Nonlimiting examples of companion fabrics include cotton, nylon, polyester, wool or acrylic. The spandex fiber of the present invention can be made by dry spinning, wet spinning, or melt spinning.” “The fiber properties are not limited to circular knitting fabric processes. Any fabric making route such as warp knitting, seamless knitting, hosiery and sock knitting as well as woven fabric process are suitable processes for the fiber of the invention.”

Also provided by the present invention are methods for reducing grin-through effect of spandex containing fabrics using the spandex fiber compositions.

As demonstrated herein, these spandex fiber compositions gave a dull luster and a grey shade to a spandex fiber resulting in significantly reduced or eliminated grin-through effect. Further, combination with a dye additive allowed for further reduction of grin-through without negatively impacting pale bright to rich dark shades

While not wanting to be limited by theory, it is believe that the grey shade formed by the low level of carbon black helps dilute the visual contrast of companion yarn dyes that get absorbed or bonded to the spandex, relative to the depth of color they would show if they were dispersed into a spandex fiber of standard-unmodified color. Further, it is believe that the addition of a specific amount of white opacity enhancer helps reduce shade changes caused by oxidative yellowing in the fiber despite the white color of these additives contrasting with the intended effects of the carbon black pigment. In addition, the inorganic pigment is believed to specifically reduce the luster of the fiber which is related to the shine of the fiber when exposed to the viewer upon stretching a fabric that contains spandex fiber while the acid dye receptor is believed to boost the color on the spandex providing rich deep shades.

All patents, patent applications, test procedures, priority documents, articles, publications, manuals, and other documents cited herein are fully incorporated by reference to the extent such disclosure is not inconsistent with this invention and for all jurisdictions in which such incorporation is permitted.

The following Examples demonstrate the present invention and its capability for use. The invention is capable of other and different embodiments, and its several details are capable of modifications and/or substitution in various apparent respects, without departing from the spirit and scope of the present invention. Accordingly, the Examples are to be regarded as illustrative in nature and non-limiting.

### Examples

Knitted fabrics as listed in Table 1 were produced in the faun of circular knit tubing on a Lawson Knitting Unit (Lawson-Hemphill Company), Model “FAK.” For items 1-21, one feed of 40 denier spandex was knit to form 100% spandex fabric. For items 22-27, one end of 40/34 flat nylon was plaited with one end of 40 denier spandex to form coknit fabric. The Lawson tubing samples were scoured at 80° C. for 30 min with 1 g/L soda ash and 1 g/L Domoscour LFE-810.

TABLE 1

| | | | | White |
|---|---|---|---|---|
| | | Carbon | Inorganic | Opacity |
| | | Black | Pigment | Enhancer |
| Reference | Companion Yarn | (ppm) | (%) | (%) |
| 1 | None (100% Spandex) | 0 | 0 | 0 |
| 2 | None (100% Spandex) | 50 | 0 | 0 |
| 3 | None (100% Spandex) | 100 | 0 | 0 |
| 4 | None (100% Spandex) | 100 | 1.5 | 0.17 |
| 5 | None (100% Spandex) | 100 | 4 | 0.32 |
| 6 | None (100% Spandex) | 150 | 0 | 0 |
| 7 | None (100% Spandex) | 200 | 0 | 0 |
| 8 | None (100% Spandex) | 250 | 0 | 0 |
| 9 | None (100% Spandex) | 0 | 1.5 | 0.17 |
| 10 | None (100% Spandex) | 60 | 1.5 | 0.17 |
| 11 | None (100% Spandex) | 80 | 1.5 | 0.17 |
| 12 | None (100% Spandex) | 100 | 1.5 | 0.17 |
| 13 | None (100% Spandex) | 100 | 1.5 | 0.17 |
| 14 | None (100% Spandex) | 100 | 1.5 | 0.17 |
| 15 | None (100% Spandex) | 100 | 1.5 | 0 |
| 16 | None (100% Spandex) | 100 | 1.5 | 0.32 |
| 17 | None (100% Spandex) | 100 | 1.5 | 0.64 |
| 18 | None (100% Spandex) | 100 | 1.5 | 0.17 |
| 19 | None (100% Spandex) | 100 | 1.5 | 0.17 |
| 20 | None (100% Spandex) | 0 | 4 | 0.17 |
| 21 | None (100% Spandex) | 0 | 4 | 0.32 |
| 22 | 40/34 flat nylon | 0 | 0 | 0 |
| 23 | 40/34 flat nylon | 50 | 0 | 0 |
| 24 | 40/34 flat nylon | 100 | 0 | 0 |
| 25 | 40/34 flat nylon | 150 | 0 | 0 |
| 26 | 40/34 flat nylon | 200 | 0 | 0 |
| 27 | 40/34 flat nylon | 250 | 0 | 0 |

Color depth of various knitted fabric made from 100% spandex that has the additive formulation noted in columns 2, 3, and 4 are depicted in Table 2. The L* is an internationally recognized scale for color depth that goes from 0-100. The lower the L value the darker the color. As carbon black loading increased, the L* value of spandex items decreased. This holds true even in the presence of inorganic pigment and white opacity enhancer. As shown, increasing TiO₂ loading also resulted in an increase in L* value. See Table 2.

TABLE 2

| | | | White | |
|---|---|---|---|---|
| | Carbon | Inorganic | Opacity | L* (Greige, |
| | Black | Pigment | Enhancer | 100% |
| Reference | (ppm) | (%) | (%) | spandex) |
| 1 | 0 | 0 | 0 | 88 |
| 2 | 50 | 0 | 0 | 77 |
| 3 | 100 | 0 | 0 | 69 |
| 6 | 150 | 0 | 0 | 69 |
| 7 | 200 | 0 | 0 | 65 |
| 8 | 250 | 0 | 0 | 65 |
| 9 | 0 | 1.5 | 0.17 | 87 |
| 10 | 60 | 1.5 | 0.17 | 71 |
| 11 | 80 | 1.5 | 0.17 | 66 |
| 12 | 100 | 1.5 | 0.17 | 67 |
| 15 | 100 | 1.5 | 0 | 61 |
| 16 | 100 | 1.5 | 0.32 | 66 |
| 17 | 100 | 1.5 | 0.64 | 71 |

Knitted fabric made from 100% spandex that had the additive formulation noted in columns 2, 3, and 4 of Table 3 were optically brightened using Phorwite CLE (1.5%) at pH 5 and 98° C. for 40 minutes. Optically brightened fabrics were exposed to burnt gas fumes under AATCC testing conditions. The ΔCIE value is the change on the CIE whiteness value after exposure to burnt gas fumes under AATCC testing conditions. The lower the amount of change the lower the impact of the burnt gas on generating a color change (e.g. less yellowing visible in the L100 item vs. the CC or C100 value.) The presence of carbon black leads to a reduction in initial CIE whiteness with the ΔCIE between initial and final whiteness being greatly reduced. See Table 3.

TABLE 3

| | | | | CIE | ΔCIE (after |
|---|---|---|---|---|---|
| | | | White | (Optically | 24 hours |
| | Carbon | Inorganic | Opacity | brightened, | burnt gas |
| | Black | Pigment | Enhancer | 100% | fume |
| Reference | (ppm) | (%) | (%) | spandex) | exposure) |
| 1 | 0 | 0 | 0 | 106 | −166 |
| 2 | 50 | 0 | 0 | 79 | −137 |
| 3 | 100 | 0 | 0 | 68 | −117 |
| 6 | 150 | 0 | 0 | 67 | −114 |
| 7 | 200 | 0 | 0 | 61 | −97 |
| 8 | 250 | 0 | 0 | 62 | −110 |
| 12 | 100 | 1.5 | 0.17 | 23 | −70 |
| 16 | 100 | 4 | 0.32 | 16 | −77 |

Knitted fabric made from 40/34 flat nylon and 40 denier spandex that had the additive formulation noted in columns 2, 3, and 4 of Table 4 were optically brightened using Phorwite CLE (1.5%) at pH 5 and 98° C. for 40 minutes. Optically brightened fabrics were exposed to burnt gas fumes under AATCC testing conditions. The ΔCIE value is the change on the CIE whiteness value after exposure to burnt gas fumes under AATCC testing conditions. Similar trends to 100% spandex fabrics were observed in optically brightened nylon/spandex fabric blends. See Table 4.

TABLE 4

| | | | | | ΔCIE (after |
|---|---|---|---|---|---|
| | | | White | CIE, | 24 hours |
| | Carbon | Inorganic | Opacity | Optically | burnt gas |
| | Black | Pigment | Enhancer | brightened | fume |
| Reference | (ppm) | (%) | (%) | samples | exposure) |
| 22 | 0 | 0 | 0 | 151 | −50 |
| 23 | 50 | 0 | 0 | 146 | −39 |
| 24 | 100 | 0 | 0 | 140 | −25 |
| 25 | 150 | 0 | 0 | 143 | −31 |
| 26 | 200 | 0 | 0 | 139 | −26 |
| 27 | 250 | 0 | 0 | 141 | −27 |

1. A spandex fiber composition comprising spandex and carbon black pigment in the range of 10-500 ppm.

2. A spandex fiber composition comprising spandex, carbon black pigment, a white opacity enhancer, an inorganic pigment or an acid dye receptor.

3. A spandex fiber composition comprising spandex, carbon black pigment, a white opacity enhancer, an inorganic pigment and an acid dye receptor.

4. The spandex fiber composition of claim 3 wherein about 25 ppm to about 200 ppm of carbon black pigment is added.

5. The spandex fiber composition of claim 2 wherein the white opacity enhancer is titanium dioxide.

6. The spandex fiber composition of claim 2 wherein about 0.01 to about 1% by weight of the white opacity enhancer is added.

7. The spandex fiber composition of claim 2 wherein about 0.01 to about 1% by weight of titanium dioxide is added.

8. The spandex fiber composition of claim 2 wherein the inorganic pigment is selected from hydrotalcite, huntite, hydromagnesite, magnesium carbonate, calcium carbonate, magnesium oxide, magnesium hydroxide and combinations thereof.

9. The spandex fiber composition of claim 2 wherein about 1% to about 10% by weight of inorganic pigment is added.

10. The spandex fiber composition of claim 2 wherein the acid dye receptor is from a tertiary and quaternary ammonium salt family or a combination thereof.

11. The spandex fiber composition of claim 2 wherein about 10 to about 50 meq active N/kg fiber of acid dye receptor is added.

12. A filament or fiber comprising the composition of claim 1.

13. An article of manufacture, at least a portion of which comprises a composition of claim 1.

14. The article of manufacture of claim 13 which is a fabric.

15. The article of manufacture of claim 14 which is a stretch fabric.

16. The article of manufacture of claim 14 wherein the fabric further comprises a companion yarn.

17. The article of manufacture of claim 16 wherein the companion yarn is selected from cotton, nylon, polyester, wool or acrylic or any combination thereof.

18. A method for reducing grin-through effect of spandex in a fabric, said method comprising producing the spandex from the spandex fiber composition of claim 1.
